(19) United States
(12) Patent Application Publication
(10) Pub. No.: US 2003/0162903 A1
(43) Pub. Date: Aug. 28, 2003

(54) High temperature stable fluorochemical graft polymers as hydrophobic, oleophobic and alcohol-resistant additives to synthetic organic polymers

(76) Inventor: James F. Day, Winston-Salem, NC (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/024,505

(22) Filed: Dec. 21, 2001

(51) Int. Cl. C08L 51/00

(52) U.S. Cl. 525/276; 525/199; 525/200; 525/221; 428/407; 428/374; 428/421

(57) ABSTRACT

This invention describes hydrophobic, oleophobic, and alcohol-resistant fibers, films, and molded articles comprising synthetic organic polymer(s) in which, dispersed within the fiber, fabric or molded article are fluorochemical graft polymeric additives. Also disclosed are the additives which confer the desirable properties to the synthetic organic polymers to which they are added. The method of preparing such fibers, films and molded articles, as well as articles made therefrom, are disclosed as well.

### FIELD OF THE INVENTION

This invention relates to fiber, film and molded article compositions comprising hydrophobic, oleophobic and alcohol resistant synthetic organic polymers. In another aspect, the present invention relates to methods for preparing hydrophobic, oleophobic and alcohol resistant fiber, film and molded articles from synthetic organic polymers. In yet another aspect, the present invention relates to fabrics comprising hydrophobic, oleophobic and alcohol resistant synthetic organic fibers and the methods of making such fabrics. In still another aspect the invention is the additive per se which confers the desirable hydrophobic and oleophobic properties and alcohol resistance to the compositions to which it is added.

### BACKGROUND OF THE INVENTION

Synthetic organic polymers are employed widely to create a variety of products. Included among such varied products are blown and cascade films, extruded sheets, foams, fibers, products made from foam and fibers, woven and knitted fabrics, non-woven fibrous webs and molded articles for garment, upholstery and medical uses, to name a few. Many polymers used in these products, such as polypropylene, exhibit some water and/or alcohol resistance but exhibit no oil resistance.

The use of various fluorochemical agents to topically treat a variety of fibers and fibrous substrates such as textiles, carpet, leather, paper and non-woven webs, to impart desirable properties to these materials, is known. See for example Mason Hayek, Waterproofing and Water/Oil Repellency, 24, Kirk-Othmer Encyclopedia of Chemical Technology, pp. 448-455 (3rd Edition 1979) or Banks, Ed., Organofluorine Chemicals and Their Industrial Applications, Ellis Horwood Ltd., Chichester, England, pp. 226-234 (1979). Such fluorochemical compositions include fluorochemical urethane and urea-based oligomers as disclosed in U.S. Pat. Nos. 3,398,182 of Guenthner et al.; 4,001,305 of Dear et al.; 4,215,205 of Landucci et al.; 4,606,737 of Stern; 4,668,406 of Chang; 4,792,354 of Matsuo et al. and 5,410,073 of Kirchner; compositions of cationic and non-cationic fluorochemicals as disclosed in U.S. Pat. No. 4,566,981 of Howells; and compositions containing fluorochemical carboxylic acid and epoxidic cationic resin as disclosed in U.S. Pat. Nos. 4,426,466 of Schwartz and 6,127,485 of Klun et al., as well as in PCT application WO 99/05345, also of Klun et al.

Also known are fluorochemical esters as disclosed in U.S. Pat. Nos. 6,063,474 of Raiford et al.; 5,859,126 of Anton et al.; 3,923,715 and 4,029,585, both of Dettre; 3,716,401 of Axelrod; and 4,264,484 of Pattel; and fluorochemical esters derived from dimerized unsaturated fatty acids as disclosed by U.S. Pat. No. 4,539,006 of Langford and WO 93/10085 of Coppens et al. These fluorochemicals can be applied to various substrates by methods known in the art, including spraying, padding, and finish bath immersion, or can be applied directly to the fiber before the fiber is woven by incorporating the fluorochemical into the fiber spin finish.

Blending a variety of fluorochemicals with synthetic organic polymers and melt extruding fibers from the molten blend to produce fiber and fibrous substrates exhibiting hydrophobicity (water resistance) and oleophilicity (oil resistance) is also known. Such patents include U.S. Pat. Nos. 5,025,052 of Crater et al.; 5,380,778 of Buckanin; 5,451,622 of Boardman et al.; 5,411,576 of Jones et al.; 5,300,587 of Mascia et al.; and 5,336,717 of Rolando et al.

While these various fluorochemical melt additives can in some cases impart satisfactory hydrophobicity and/or oleophobicity to resins, many suffer poor thermal stability above 300° C., which is a melt processing temperature often encountered in the industry. Moreover, many prior art additives are prohibitively expensive.

Others, such as the melt additives of Klun et al., U.S. Pat. No. 6,127,485 and WO 99/05345, are thermally stable at high processing temperatures but are required to be used in unacceptably high amounts so as to make them economically undesirable. Moreover, some such additives, because of their high stability, have been found to biopersist, and may accumulate to cause serious damage to humans. In fact, some of these compounds are currently being phased out of use in the United States due to suspicion that they may be potential biohazards.

### SUMMARY OF THE INVENTION

In one aspect, the invention relates to a hydrophobic, oleophobic and alcohol resistant fiber comprising a synthetic organic polymer and one or more fluorochemicals selected from the group consisting of graft polymers comprising a reactively (e.g., carboxylic acid or anhydride) graft-modified polyolefin backbone with which are reacted m moles of one or more groups of the formulae

[(Rƒ)n-Q-O]— (I)

[(Rƒ)n-Q-C(O)—O]— (II)

[(Rƒ)n-Q-N(R₁)]— (III)

[(Rƒ)n-Q-C(O)—N(R₂)] (IV)

[(Rƒ)n-Q-S]— (V)

[(Rƒ)n-Q-N(R₃)—O]— (VI)

[(Rƒ)n-Q-OC(O)]— (VII)

[(Rƒ)nQ-N(R₄)—C(O)]— (VIII)

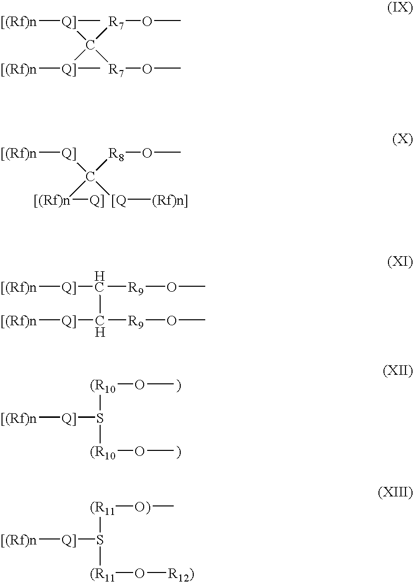

in which Rƒ is a fluorinated straight-chain or branched alkyl group bonded through carbon; n is 1 or 2; Q is a divalent or trivalent linking group, where the divalent linking group can be a covalent bond, or Q may be a straight-chain or branched alkyl, alkoxy or alkylthio group; R₁ through R₁₂ are independently selected from the group consisting of a hydrogen atom or a substituted or unsubstituted alkyl group; and m is a number between about 4 and r, preferably between 6 and r, and more preferably between 10 and r, r being the number of reactive (e.g., acid or anhydride groups) in the modified olefin polymer, (i.e., the number of acid groups or twice the number of anhydride groups in the polymer).

In another aspect, the invention is a film comprising a synthetic organic polymer and one or more fluorochemicals selected from the group consisting of graft polymers comprising a grafted reactively-modified polyolefin backbone with which are reacted m moles of one or more groups as described above.

In another aspect, the invention is a method of rendering synthetic organic polymers hydrophobic, oleophobic and alcohol resistant, comprising blending with the polymer one or more fluorochemicals selected from the group consisting of compounds of the above formulae.

In another aspect, the invention is a molded article comprising synthetic organic polymer and one or more fluorochemical graft polymers selected from the same group as described above.

In a preferred aspect, the invention is a hydrophobic, oleophobic and alcohol resistant fiber comprising a synthetic organic polymer and one or more fluorochemical graft polymers selected from the group consisting of graft polymers comprising a carboxylic acid-, anhydride-, or amine-graft modified polyolefin backbone with which are reacted h moles of one or more groups of the formula (XIV):

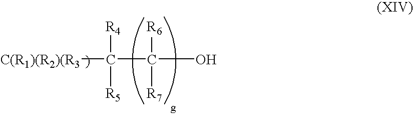

in which g is a number from 1 to about 40 and preferably about 4 to about 12 and in which R₁, R₂, R₃, R₄, R₅, R₆ and R₇ are independently selected from the group consisting of hydrogen and fluorine, wherein at least 30% and preferably at least 75% of said R₁-R₇ groups are fluorine and wherein h is a number between about 4 and p, preferably between 6 and p, and more preferably between 10 and p,p being the number of carboxylic acid or amine groups in the backbone or twice the number of anhydride groups in the backbone.

In two other aspects, the invention is a film or a molded article comprising a synthetic organic polymer and one or more fluorochemicals selected from the group consisting of graft polymers comprising a reactive group (e.g., carboxylic acid-, anhydride-, or amine-) graft-modified polyolefin backbone with which are reacted h moles of groups of the formula (XIV) above.

In still another aspect, the invention is a method of rendering synthetic organic polymers hydrophobic, oleophobic and alcohol-resistant, comprising blending with the polymer one or more fluorochemicals selected from the group consisting of graft polymers comprising a carboxylic acid-, anhydride-, or amine-modified polyolefin backbone with which are reacted h moles of one or more groups of the above formula (XIV), wherein h is a number between about 4 and p, preferably between 6 and p, and more preferably between 10 and p, p being the number of carboxylic acid or amine groups in the backbone or twice the number of anhydride groups in the backbone.

The above-depicted fabrics, fibers and articles enjoy improved hydrophobic and oleophobic properties and alcohol resistance relative to those of the prior art when the melt additives are combined with the polymers prior to their thermal extrusion. The fluorochemical graft polymers and fluorochemical compositions including them also offer the additional benefits of thermal stability above 300° C. and yield lower material cost compared to currently employed fluorocarbon polymer additives, without the potential for biopersistence which may exist with some prior art fluorochemical additives.

In still other aspects, the invention is an additive that confers hydrophobic, oleophobic and alcohol resistance properties to a synthetic organic polymer composition to which it is added. The additive comprises a fluorochemical graft polymer of a reactively-modified polyolefin having at least about four, preferably at least about 10, fluorochemical groups reacted therewith per mole of reactively-modified polymer. Preferably, this number of fluorochemical groups corresponds to at least 30%, preferably at least 50%, and more preferably at least 75% by number of reactive groups which are grafted to the polymer backbone.

In further aspects, the invention is an additive that confers hydrophobic, oleophobic and alcohol resistance properties to a synthetic organic polymer composition to which it is added which comprises one or more of the fluorochemical graft polymer compounds described above.

### DETAILED DESCRIPTION OF THE INVENTION

Those compounds used in the practice of this invention are selected from the group consisting of fluorochemical graft polymers comprising a reactively graft-modified polyolefin backbone with which is reacted through the grafted reactive groups m moles of one or more fluorochemical groups of the formulae

[(Rƒ)n-Q-O]— (I)

[(Rƒ)n-Q-C(O)—O]— (II)

[(Rƒ)n-Q-N(R₁)]— (III)

[(Rƒ)n-Q-C(O)—N(R₂)] (IV)

[(Rƒ)n-Q-S]— (V)

[(Rƒ)n-Q-N(R₃)—O]— (VI)

[(Rƒ)n-Q-OC(O)]— (VII)

[(Rƒ)nQ-N(R₄)—C(O)]— (VIII)

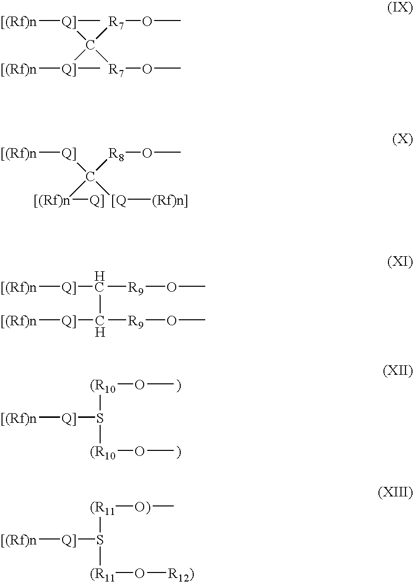

in which Rƒ is a fluorinated straight-chain or branched alkyl group bonded through carbon; n is 1 or 2; Q is a divalent or trivalent linking group, where the divalent linking group can be a covalent bond or Q may be a straight-chain or branched alkyl, alkoxy or alkylthio group; R₁ through R₁₂ are independently selected from the group consisting of a hydrogen atom or a substituted or unsubstituted alkyl group; and m is a number between 4 and r, r being the number of reactive groups in the modified olefin polymer. Preferably, m is a number between about 4 and the total number of reactive groups in the modified polymer, more preferably between about 6 and about 40, and still more preferably between about 10 and about 18. It is preferable that at least 30% by number, more preferably 50% by number, and still more preferably, 75% by number of the grafted-on reactive groups are reacted with fluorochemical reactant. In other preferred embodiments, the reactive group which is grafted to the backbone is a carboxylic acid or carboxylic acid anhydride, in which case the number r is the number of carboxylic acid groups in the backbone polymer, or twice the number of anhydride groups in said polymer.

The backbone may be comprised of any aliphatic polymer or oligomer, straight chain or branched, saturated or unsaturated. It may exist in a liquid or more commonly in a solid form, such as a wax. The molecular weight of the backbone portion should be sufficiently high so as to afford nonvolatility to the composition, as distinct from short chain additives such as the fatty acids of the prior art. The molecular weight may be within the range of about 1000 to about 5000 or higher. The upper limit of the molecular weight is set by processability conditions rather than any deleterious results; if satisfactory processing can occur at higher molecular weights, higher molecular weights may be employed as well. In a more preferred embodiment the molecular weight should be at least about 2000, more preferably, about 2800. Molecular weights below about 1000 may be too low to prevent volatility of the compound under processing conditions for the synthetic organic polymer that is being treated; the compounds used in the present invention are thermally stable when they are subjected to temperatures of 300° C. or higher, for one minute, or preferably for ten minutes, with 300° C. and ten minutes representing typical processing conditions used in a spun blown process by which articles of synthetic organic polymer may be made. The backbone is preferably largely hydrocarbon in nature, and is preferably olefinic. Examples of such olefins include polypropylene, polyethylene, polybutylene, polybutadiene, polyisoprene and the like.

The olefinic backbone of the fluorochemical graft polymer is modified by grafting thereto compounds incorporating groups that allow the subsequent reaction of fluorochemical moieties with the backbone. Such grafted groups include but are not limited to acid groups, anhydride groups, alcohol groups, epoxy groups, mercaptyl groups, ethyleneoxide groups, amide groups, ethanolamine groups and amine groups. In a preferred embodiment, the reactive groups are acid or anhydride groups that are grafted onto the polyolefin backbone by reaction of a polyacid or anhydride with available reactive groups in the olefinic backbone, preferably by Diels-Alder reaction. A suitable method for grafting reactive groups to a polypropylene backbone is described in WO 00/56065 of Coe, herein incorporated by reference in its entirety.

Examples of the acid or anhydride-providing compounds which may be used as the grafting compound used to make the graft-modified backbone of the invention include any low molecular weight (poly)carboxylic acid of relatively low molecular weight, e.g., fumaric acid; fumaric anhydride; itaconic acid; itaconic anhydride; vinyl acetic acid; vinyl acetic anhydride; norbornene dicarboxylic acid; norbornene tricarboxylic acid; norbornene anhydride; cyclopentadiene dicarboxylic acid; cyclopentadiene tricarboxylic acid; cyclopentadiene anhydride; cyclohexyl dicarboxylic acid; cyclohexyl tricarboxylic acid; cyclohexyl anhydride; and so forth.

A preferred reactively graft modified olefinic polymer for the backbone is comprised of a wax, whose CAS No. is 25722-45-6, and which comprises high molecular weight maleic anhydride grafted-polypropylene having an acid value of about 37-43 mg KOH/g; a density of 20° C. at 0.89-0.93 g/cm²; and a softening point of 154-158° C.

In a variation of the embodiment in which the backbone is modified through grafting with a carboxylic acid or anhydride, the anhydride or other acid-conferring group may be reacted into the backbone itself, the result of which is a polyolefin backbone having the reacted groups directly incorporated therein. Some examples of polymers which meet this definition include a copolymer of styrene and maleic anhydride or other anhydride, which is optionally cumene-terminated; copolymer of methyl vinyl ether with maleic anhydride or other anhydride; copolymer of maleic or other anhydride with any one or more of: acrylic acid or methacrylic acid or their derivatives; acrylates or methacrylates; acrylonitrile; acrylonitrile-butadiene; polyvinyl chloride; vinyl acetate; or the like. Also suitable are terpolymers or any of the above with unsaturated aliphatic monomers such as isobutylene; isoprene; or other one- to forty-carbon monomer.

In the embodiment wherein the backbone is to be modified through grafting with a reactive group other than acid or anhydride, there may be used any straight chain or branched low molecular weight compound which can be grafted onto the backbone to provide to the backbone a reactive alcohol, thiol, epoxy, urea, alkanolamine, amide or amine group. Examples include the alcohol, thiol, epoxy, urea, amide, amine or alkanolamine derivatives of the low molecular weight compounds described in the previous paragraph and include vinyl alcohol; ethanol; methanol; butanol; propanol; hydroxy norbornene; cyclohexanol; hydroxy cyclopentadiene; ethyl amine; methyl amine; methyl amide; butyl amine; butyl amide; propyl amine; propyl amide; mercaptopropane; mercaptoethane; norbornenyl amine; cyclopentadiene amine; cyclohexylamine; mercaptopropane; mercaptobutane; epichlorohydrin; ethanolamine; propanolamine; and so forth. Of course, the reactive group which is grafted to the backbone is selected to be one which is reactive with the fluorochemical reactant which is to be reacted therewith.

The higher the proportion of acid or anhydride or other reactive group which is grafted to the backbone, the more sites are available for subsequent reaction with the fluorohemical reactant, and the more efficient the resulting fluorochemical graft polymer. A preferred modification is effected by grafting enough reactive groups to the backbone such that the final graft polymer, after reaction with the fluorochemical reactant, contains at least 30 and up to 100 fluorine-containing groups per 100 monomeric residues in the (pre-grafted) backbone, i.e., the graft polymer product contains at least 30%, preferably 50%, more preferably 75%, and still more preferably nearly 100%, of fluorochemical groups, based on the number of monomeric residues in the (pre-grafted) backbone. In the case of a grafted reactive group including more than one reactive site, an optimized number of reactive groups corresponds roughly to 1/x moles of reactive-moiety conferring reactant, wherein x is the number of reactive groups conferred by the reactant. These percentages correspond to at least four, preferably at least 6, and more preferably at least about 10, fluorochemical groups per mole of fluorochemically modified graft polymer. A suitable range of number of fluorochemical groups is between about 4 and about 40, preferably about 6 to 18, and more preferably between about 10 and about 18, moles of fluorochemical group per mole of fluorochemical graft polymer. At higher proportions of reactive moiety-conferring reactant to backbone, steric hindrance may play a deleterious role. For instance, in one preferred embodiment, a polypropylene backbone has grafted thereto k moles of maleic anhydride, wherein k is a number equal to or slightly in excess of half the monomeric residues in the backbone. The modifying or grafting group may be added to the olefinic backbone by any method known in the art. In a preferred method, an anhydride group is grafted to every other monomeric residue in the polyolefin backbone by Diels-Alder reaction as discussed in WO/52065, referred to above.

The fluorochemical reactants used in this invention are fluorinated compounds selected to contain a functionality that is compatible (reactive) with the reactive group which is grafted to the backbone. Such functionalities are conferred by reactants such as alcohols, ureas, urethanes, amides, mercaptans, amines, acids, thiols, epoxy groups, acids or ethanolamines, these functionalities being selected to be capable of reacting with the pendant reactive groups which are grafted to the backbone of the graft copolymer of the invention.

With regard to the fluorochemical portion of the fluorochemical reactant, Rƒ, this moiety may be a partially fluorinated or perfluorinated straight or branched chain group comprising about 2 to about 40 carbon atoms in length, more typically about 6 to about 18 carbon atoms. This fluorochemical group may be completely fluorinated or may have some hydrogen substituents, i.e., between 2 and about 6. In a preferred embodiment the group Rƒ is tetrahydro-substituted, with the remaining substituents being fluorine. In other preferred embodiments, the fluorochemical group contains a terminus of either (CH₃—) or (CHF₂—). In still other embodiments, the fluorochemical group of the fluorochemical reactant may comprise a long chain perfluoro-group, optionally partially hydrogen substituted, at one end of which is a sulfonamide group. In yet other embodiments, all of the carbon atoms of the reactive fluorochemical portion of the reactant may be completely fluorinated. In still other embodiments, the fluorochemical portion of the reactant may be branched, e.g., by up to about ⅓, as described in U.S. Pat. No. 6,048,952 of Behr et al., herein incorporated by reference.

The group Q which joins the reactive moiety of the fluorochemical reactant to the fluorochemical portion, may be a divalent or a trivalent linking group, or may be a branched or straight chain alkyl, alkoxy, or alkylthio group, optionally interrupted by other heteroatoms. In some embodiments, it may comprise a combination of the above-described moieties. The chemical makeup of the linking group Q is not important so long as it neither interferes with the binding of the fluorochemical reactant with the graft modified backbone, nor deleteriously effects the properties of the end product.

In addition to relatively simple fluorochemical reactant compounds in which the fluorochemical group is bonded to a single reactive group by a covalent bond, there may be used compounds which contain more than one reactive group; compounds that are branched; and compounds that include Q groups which may contain carbon, hydrogen, and heteroatoms. A non-limitative group of other such fluorochemical reactants is listed below:

(Rƒ)-CH₂ CH₂CH₂—O—(CH₂ CH₂CH₂—O)_{z}H

(Rƒ)-CH₂ CH₂CH₂—S—(CH₂ CH₂CH₂O)_{z}H

(Rƒ)-CH₂CH₂—O—(CH₂CH₂CH₂O)_{z}H

(Rƒ)-CH(CH₃)—O—(CH₂CH₂CH₂O)_{z}H

(Rƒ)-(CH₂CH₂O)_{z}C(O)—OH

(Rƒ)-(CH₂CH₂)_{z}C(O)—OH

(Rƒ)-(CH₂CH₂CH₂O)_{z}C(O)—OH

(Rƒ)-(CH₂CH₂O)_{z}CH₂—NH₂

(Rƒ)-(CH₂CH₂CH₂O)_{z}CH₂—NH₂

(Rƒ)-(CH₂CH₂—S—CH₂ O)_{z}CH₂—NH₂

(Rƒ)-CH(CH₃)CH₂—NH₂

(Rƒ)-CH₂CH₂CH₂—NH₂

(Rƒ)-CH₂CH₂—S—CH₂—NH₂

(Rƒ)-(CH₂CH₂O)_{z}—C(O)—NH—CH₂CH₂—OH

(Rƒ)-(CH₂CH₂CH₂O)_{z}CH₂—SH

(Rƒ)-CH₂CH₂CH₂CH₂—SH

(Rƒ)-(CH₂CH₂CH₂O)_{z}—C(O)—NH CH₂CH₂—OH

(Rƒ)-CH₂CH₂—C(O)—NH CH₂CH₂—OH

(Rƒ)-C(O)—CH₂CH₂—SH

(Rƒ)-C(O)—CH₂CH₂CH₂CH₂—SH

(Rƒ)-C(O)—(CH₂CH₂CH₂O)_{z}—CH₂CH₂CH₂O—NH₂

(Rƒ)-C(O)—CH₂CH₂O CH₂CH₂O—NH₂

(Rƒ)-NH₂—CH₂CH₂CH₂OCH₂—C(O)OH

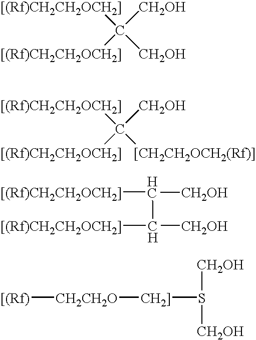

wherein z may be a number from 1 to about 40 and wherein Rƒ is a branched or straight chain fluorinated group as defined elsewhere herein. Also, epoxidized variants of the above may be used.

Typically, m moles of the fluorinated reactant are used, with m being a number between about 4 and about r, preferably between about 6 and about r, and more preferably between about 10 and r, with r being the number of reactive groups, e.g., the number of acid groups that are pendant from the graft-modified backbone, or twice the number of anhydride groups, in the embodiments where the backbone is either acid or anhydride modified.

Preferred fluorochemical compounds of this invention are graft polymers comprising a carboxylic acid-, anhydride-, or amine-graft modified polyolefin backbone with which are reacted h moles of one or more groups of the formula (XIV):

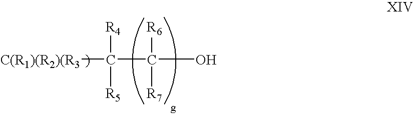

in which g is a number from 0 to about 40, preferably about 4 to about 12, and in which R₁, R₂ R₃, R₄, R₅, R₆ and R₇ are independently selected from the group consisting of hydrogen and fluorine, wherein at least 30%, more preferably about 50%, and still more preferably about 75% of said R1-R7 groups are fluorine, and wherein h is a number between 4 and p, p being the number of carboxylic acid or amine groups in the, backbone or twice the number of anhydride group, in the backbone. While h may be a number from about 4 to about p, it is preferably a number from 6 to 40, and preferably from about 10 to about 18.

A preferred fluorochemical reactant which the fluorinated graft polymer is made is Zonyl® BA fluorotelomer from DuPont Chemical Enterprises, Wilmington, Del. This is a mixture of six- to eighteen-carbon 1,1,2,2-tetrahydroperfluoro-1-alcohols, the majority of which are eight to twelve carbon atoms in length. The mixture has a boiling point of 145-245° C. at 1 atm; a melting point of 55-65° C. and a specific gravity of 1.7.

The reaction that forms the fluorochemical graft polymer is typically a process involving reacting the reactively-modified grafted backbone material. In a preferred embodiment, maleic anhydride-grafted polypropylene is reacted with twice the molar amount of a fluorinated reactant, e.g., a telomeric mixture of tetrahydroperfluoro alkanols having a carbon chain length distribution of between about 6 and about 18 carbon atoms relative to the number of maleic anhydride groups. The first mole of the fluorinated reactant reacts readily with the anhydride group to form an ester. In the presence of heat (e.g., 150-160° C.) and an acid catalyst such as methanesulfonic acid, a titanate catalyst, or any of the esterification catalysts well known in the art, the reaction of the second mole of fluorinated reactant is completed. In other embodiments, the fluorinated reactant may be a terminally substituted amine, mercaptan, alkoxy, ethanolamine, urea, or urethane again having a carbon chain length of about 4 to about 40 carbons, preferably 6 or more carbon atoms, and again being either fully or highly fluorinated. This reactant may be a telomeric mixture of fluorochemical compounds of different chain length, or may be a ‘single cut’, or homogeneous solution, vis-à-vis chain length.

It is a surprising and unexpected advantage of this invention that such fluorochemical graft polymers as are used in this invention are particularly useful in imparting hydrophobic and oleophobic properties, i.e., resistance to water, alcohol and oily substances, to synthetic organic polymers to which they are added, while providing high thermal stability at lower than expected dosages, based on dosages required by the prior art. It has long been believed that in order for a fluorochemical agent to provide maximal effectiveness in terms of stain resistance, hydrophobicity and oleophobicity, the fluorochemical agent needs to be oriented within an aliphatic material such that the fluorinated moieties reside fairly exclusively at one or more surfaces of the substrate which is treated, with only the aliphatic portion embedded within the substrate. It has surprisingly been found that the fluorochemical graft polymers of this invention, which have fluorochemical moieties along their entire length such that the fluorochemical moieties are seeded within and throughout the substrate, are actually more effective than the prior art fluorochemical agents, even at considerably lower concentrations than where required in the prior art. Moreover, it is a surprising advantage that the fluorochemical graft polymers of this invention are more readily biodegradable than prior art biopersistent agents.

The ester compositions which result in one embodiment by reacting acid or anhydride-graft modified polyolefin backbone with a fluorinated alcohol may be made conveniently by heating a fluorochemical alcohol with either the acid- or anhydride-graft modified backbone composition in the presence of a standard acid catalyst such as p-toluenesulfonic acid, preferably in a suitable solvent such as toluene. They also can be prepared by first making an acid chloride of the acid or anhydride groups, then reacting with a fluorochemical alcohol at a slightly elevated temperature in the presence of an acid scavenger.

Amide compositions as are made in an alternate embodiment can be prepared by reacting a fluorochemical amine with an acid- or anhydride-graft modified backbone by heating the components together neat at an elevated temperature (at least 220° C.). Alternatively, they can be prepared by first making an acid chloride with a fluorochemical amine at a slightly elevated temperature (50-60° C.), and preferably in a low-boiling solvent such as chloroform.

In an alternate embodiment, the fluorochemical graft polymer may be made in situ, i.e., by exposing the substrate which is to be treated to a bath including both reactants, i.e., the reactive group-modified material and the fluorochemical reactant which is to react with it. The reactants can be made to react to form the fluorochemical graft polymers by the same methods as described above for making the compounds prior to mixture with the substrate to be treated.

As used herein, the terms “fiber” and “fibrous” refer to an elongated article, generally of thermoplastic resin, wherein the length to diameter ratio of the article is greater than or equal to about 10. Fiber diameters may range from about 0.5 micron up to at least 1,000 microns. Each fiber may have a variety of cross-sectional geometries, may be solid or hollow, and may optionally be colored. The fluorochemicals of this invention modify both the surface and the bulk of the individual fibers in a uniform way.

The described fluorochemical graft polymers and compositions comprising them find particular utility as additives to synthetic organic polymers. Synthetic organic polymeric films, fibers, and molded articles to which the fluorochemicals are added have low surface energy, excellent oil and water repellency, and resistance to soiling. Such synthetic organic polymers include but are not limited to polyamides including nylon 6 and nylon 66; polyesters such as polyethylene terephthalate; polyolefins such at polypropylene and polyethylene; epoxy resins; urethanes; acrylics; polystyrenes; etc. The fluorochemical graft polymers of the invention can also be used as blends with other fluorochemicals or other additives.

Fibers, films, and molded articles containing the fluorochemical graft polymers can be made by preparing a blend of the solid fluorochemical graft polymer or fluorochemical composition with a chosen solid synthetic organic polymer by intimately mixing the fluorochemical with pelletized or powdered polymer, and melt extruding the blend into fibers or films by methods well-known in the art. The reactants or fluorochemical compositions can be mixed directly with the synthetic organic polymer or they can be mixed in a ‘master batch’. An organic solution of the reactants that make up the fluorochemical graft polymer composition or the graft polymer per se may also be mixed with powdered pelletized synthetic organic polymer, the mixture dried to remove solvent, then melted and extruded. Alternatively, the molten reactants or fluorochemical graft polymer per se can be injected into a molten polymer stream to form a blend immediately prior to extrusion.

The amount of fluorochemical graft polymer used as an additive is that amount sufficient to achieve the desired properties of oil, alcohol and water repellency and/or soiling resistance. Preferably, the amount of additive to be used will be that amount which provides from about 100 to 20,000 ppm of fluorine, more preferably 200 to 10,000 ppm fluorine, based on weight of fiber of film. It is noted that the fluorochemicals of the present invention may be more efficient than those of the prior art and may therefore be effective in lower than expected doses.

After extrusion, an annealing step may be carried out and/or the extrudate may be embossed by methods known in the art.

The fluorochemical graft polymer additives of the invention also may be used as aqueous suspensions or emulsions, or as organic solvent solutions in the treatment of textile fibers or filaments during manufacture, e.g., in combination with spin finishes, or in the treatment of porous or fibrous substrates such as textiles, carpets, paper and leather to impart oil, alcohol and water repellency and anti-soiling properties thereto. The fluorochemical treatment may, for example, be carried out by immersion in a cationic, anionic or nonionic bath, and spin finishing. Alternatively, the fluorochemical graft polymer can be co-applied with conventional fiber treating agents such as anti-static or lubricating agents.

The fluorochemical graft polymers of this invention may also find utility in making non-woven fabrics or melt- or spun-bonded webs by processes known in the art. Multi-layer constructions made from non-woven fabrics enjoy wide industrial and commercial utility and include uses such as medical fabrics, apparel, industrial apparel, outdoor fabrics, home furnishings, table linens, shower curtains, and many other uses.

Films of the invention can be made from blends of synthetic organic polymer and the described fluorochemical graft polymers by any film making method commonly employed in the art. Such films may be non-porous, porous or microporous, where the presence and degree of porosity is selected according to desired performance characteristics.

The fluorochemical graft polymers of the invention also can find utility as additives to polymer coatings and articles, e.g., to improve water resistance, lower surface energy, improve dielectric properties, and so on.

### Test Methods

Each of the test methods employed herein were the same as described in WO 99/05345, herein incorporated by reference in its entirety.

Melt-Blown Extrusion Procedure: The melt-blown extrusion procedure was the same as described in U.S. Pat. No. 5,300,357, col. 10, herein incorporated by reference. The extruder that was used is a Brabender 42 mm conical twin-screw extruder, with maximum extrusion temperature of 270-280° C. and distance to the collector of 12 inches (30 cm).

Mixtures of the fluorochemical graft polymer and the synthetic thermoplastic polymer were made by blending in a paperboard container using a mixer head affixed to a hand drill for about one minute until a visually homogeneous mixture was obtained.

The process conditions for each mixture were the same, including the melt blowing die construction used to blow the microfiber web (50±5 gm/cm²) and the diameter of the microfibers (5-518 micrometers). Unless otherwise stated, the extrusion temperature was 210° C., the pressure was 124 kPa (18 psi) with a 0.076 cm air gap width, and the polymer throughput was about 180 g/hr/cm.

Spunbond Extrusion Procedure: The extruder used was a Reifenhauser Extruder Model Number RT 381 (available from Reifenhauser Co., Troisdorf, Nordrhein Wesfalen, Germany). The extruder was driven by an infinitely variable 3ø shunt wound DC motor, 37.3 kW& 2200rev/min max. The maximum screw speed was reduced to 150 rev/min. The screw was 70 mm in diameter and 2100 nun in length. The entire extruder was 2.3 m in length by 1.3 m in width by 1.6 m in height, weighing 2200 kg. There were five 220 V heating zones at a total 22.1 kW of heating power, giving a maximum heating zone temperature of 210° C.

The bonder was a Kusters Two-Bowl-Thermobonding-Calendar (available from Kusters Corp., Nordrhein Westfalen, Germany). The effective bonding width was 1.2 m. The upper patterned metal roll had a 15% bonding area and a temperature of 270° F. (132° C.), while the lower rubber roll had a slick surface and a temperature of 265° F. (129° C.), the bonding nip pressure was 57-860 pounds of force per linear inch (3000-46,000 J/cm). The rolls were heated by convection from continuously circulating furnace oil. The temperature range of the nips was 200-300° F. (93-149° C.). The bonder's speed was directly synchronized to the speed of the collection belt that had a range of 3.6 to 65 linear meters per minute.

The basis weight for the nonwoven web (in g/m²) can be calculated by multiplying the speed of the spin pump (rev/m) times the constant 71.

Embossing Procedure: Nonwoven samples were embossed using a top roll with a 15% contact area diamond pattern metal top roll set at 98° C. and a rubber bottom roll set at 104° C., with a gap between the rolls of less the 2 mil (50 microns), at a pressure of 30 psi (1550 torr) between the top and bottom rolls, and at a linear speed of 8.3 ft/min(2.5 m/min).

Thermal Gravimetric Analysis (TGA) Test: Unless otherwise stated, a DuPont Instruments Model 951 Thermogravimetric Analyzer was used, and the sample was heated from room temperature at a rate of 10° C./min. The percent of the sample left when a given temperature was reached (usually 220° C., 280° C., 320° C. and 340° C.) was reported. It is desirable to have at least about 90% of the sample remaining after heating to 320° C. so that the fluorochemical graft polymer is resistant to high temperature processing.

In a variant of this test, a sample of fluorochemical graft polymer is heated at a rate of 100° C./min to 220° C., 280° C. or 320° C. and held at the respective temperature. The percent of the sample left after different numbers of minutes was measured and recorded as “% TGA remaining”.

Water Repellency Test: Nonwoven web samples were evaluated for water repellency using 3M Water Repellency Test V for Floorcoverings (February 1994), available from 3M Company. In this test, samples are challenged to penetrationns by blends of deionized water and isopropyl alcohol (IPA). Each blend was assigned a rating number as shown below:

| | Blend (% by volume, |
|---|---|
| Water Repellency Rating | water/IPA) |
| 0 | 100% water |
| 1 | 90/10 |
| 2 | 80/20 |
| 3 | 70/30 |
| 4 | 60/40 |
| 5 | 50/50 |
| 6 | 40/60 |
| 7 | 30/70 |
| 8 | 20/80 |
| 9 | 10/90 |
| 10 | 100% IPA |

In running the Water Repellency Test, a nonwoven web sample was placed on a flat, horizontal surface. Five small drops of water or a water/fluorochemical graft polymer sample were gently placed at points at least two inches apart on the sample. If, after observing for ten seconds at a 45° angle, four of the five drops were visible as a sphere or a hemisphere, the nonwoven web sample was deemed to have passed the test. The reported water repellency rating corresponds to the highest numbered water or water/mixture for which the nonwoven sample passed the described test.

It is desirable to have a water repellency rating of at least four, preferably at least six.

Oil Repellency Test: Nonwoven web samples were evaluated for oil repellency using 3M Oil Repellency Test III (February 1994), available from 3M Company, St. Paul, Minn. In this test, samples are challenged to penetration by oil or oil mixtures of varying surface tensions. Oils and oil mixtures are given a rating corresponding to the following:

| Repellency Rating No. | Oil Composition |
|---|---|
| 0 | (fails Kaydol ™ mineral oil) |
| 1 | Kaydol ™ mineral oil |
| 2 | 65/35 (vol.) mineral oil/n-hexadecane |
| 3 | n-hexadecane |
| 4 | n-tetradecane |
| 5 | n-dodecane |
| 6 | n-decane |
| 7 | n-octane |
| 8 | n-heptane |

The following examples are offered by way by of illustration only and to aid in the understanding of the invention. They are not to be construed as limiting the scope of the invention.

### EXAMPLES

In the examples below, unless otherwise indicated, the wax that is used is a granular, high molecular weight maleic anhydride-modified polypropylene having an acid value of 37-43 mg KOH/g; a density of 20° C. of 0.89-0.93 g/cm²; and a softening point of 154-158° C.

The alcohol identified in the examples as Zonyl ® BA is a fluorotelomer from DuPont Chemical Enterprises, Wilmington, Del. It is a mixture of even-numbered C6-C18 1,1,2,2-tetrahydroperfluoro-1-alcohols, the majority of which are between 8 and 12 carbon atoms in length. The mixture has a boiling point of 145-245° C. (293-473° F.) at 1 atm; a melting point of 55-65° C. (131-149° F.) and a specific gravity of 1.7.

Escorene™ PP3505 is polypropylene having a melt flow rate of 400, which is commercially available from Exxon Chemical Company, Baytown, Tex.

Aspun™ 6806 is polyethylene having a melt index of 105 g/10 min (as measured by Test Method ASTM D-1238) and a peak melting point of 124.8° C. It is commercially available from Dow Chemical Company, Midland Mich.

Morthane™ PS 400 is a thermoplastic polyurethane resin having a Shore A Hardness (one sec delay) of 89 and a melting point range of 140-210° and is commercially available from Shell Chemical Company.

PET 35 is polyethylene terephthalate that is commercially available from BASF Corporation, Mt. Olive, N.J.

Ultramid™ B-3 is nylon 6 polyamide resin having a melting point of 220° C., a number average molecular weight of 15,000 and a melt viscosity of 140 Pa·s at 250° C. (D=1000 s⁻¹). It is commercially available from BASF Corp., Parsippany, N.J.

Unless otherwise indicated in the examples, all parts and percentages are by weight. Whenever a “control” is designated, it signifies a composition identical to the one which is tested but lacking the additive described in that example.

### Synthesis of Fluorochemical Graft Polymers

### EXAMPLE 1

A 12 liter round-bottom flask is charged with 3456 grams of the maleic anhydride-modified polypropylene wax discussed above (CAS-number 25722-45-6); 1756 grams Zonyl ® BA C₆-C₁₈ tetrahydroperfluoro-1-alcohol telomer (DuPont Chemical Enterprises); 7 grams 70% aqueous methanesulfonic acid; and 600 grams o-xylene. The reaction mass is heated, with stirring, to 150-160° C. and reaction water is azeotroped out with o-xylene until an acid value is less than 1 mg KOH/g sample is obtained. The o-xylene solvent is vacuum distilled off at 160° C. under full vacuum. The molten reaction mass is flaked or discharged to trays and allowed to freeze. The product is then ground to a powder. The yield is 5175 grams of a light tan solid, melting at 152° C. The fluorine content was determined to be 22.77% by weight. The TGA profile as percent product remaining was determined at the following temperatures. This fluorochemical graft polymer product is referred to hereinbelow as FC-1.

| | | | | |
|---|---|---|---|---|
| Temperature | 220° C. | 280° C. | 320° | 340° C. |
| % Remaining | 97 | 96 | 94 | 93 |

### EXAMPLE 2

Example 1 was repeated in a vented 15 liter rotary ball mill/dryer with external heating without the o-xylene solvent. The reaction mass was heated at 155° C. until the acid value was less than 2 mg KOH/gram sample. The yield was 5160 grams of tan power with a melting point of 152.4° C. and a fluorine content of 22.6% by weight.

### EXAMPLE 3

Example 2 was repeated at 5% scale in a Brabender Prep Center. The reaction mass was held at 160° C. until the acid value was less than 17 mg KOH/gram sample. Methanesulfonic acid was added and the reaction was heated to 180-190° C. until the acid value was less than 4 mg KOH/gram sample. The yield was 210 grams of a tan solid melting at 154° C. with a fluorine content of 22.1% by weight.

### Use of Fluorochemical Graft Polymer to Confer Hydrophobicity and Oleophobicity to Synthetic Organic Polymers

Non-woven Fabrics

Escorene™ PP 3505 chips were blended with the fluorohemical graft polymer FC-1 described in Example 1 above at 1.00 percent by weight solids and thermally extruded into non-woven webs using the Melt-Blown Extrusion Procedure. The non-woven webs were evaluated for repellency using the above-described Water Repellency and Oil Repellency Tests. Both tests were done immediately after extrusion; after holding for ten days at room temperature; and after the above-described Embossing Procedure was performed.

Escorene ™ PP 3505

| | Water Repellency | | | Oil Repellency | | |
|---|---|---|---|---|---|---|
| | Initial | 10 days | Embossed | Initial | 10 days | Embossed |
| Control | 2 | 2 | 2 | 0 | 0 | 0 |
| FC-1 | 8 | 8 | 9 | 3 | 1 | 4 |

The procedure described immediately above was repeated except using four different polymers: Aspun™ 6806 polyethylene; Morthane™ PS 400 polyurethane; PET 35 polyethylene terephthalate; and BASF Ultramid™ B-3 nylon; the results are described below.

| Water Repellency | | | Oil Repellency | | |
|---|---|---|---|---|---|
| Initial | 10 days | Embossed | Initial | 10 days | Embossed |

Aspun ™ 6806 Polyethylene

| | | | | | | |
|---|---|---|---|---|---|---|
| Control | 2 | 2 | 2 | 0 | 0 | 0 |
| FC-1 | 9 | 9 | 9 | 3 | 1 | 2 |

Morthane ™ PS 400 Polyurethane

| | | | | | | |
|---|---|---|---|---|---|---|
| Control | 2 | 2 | 3 | 0 | 0 | 0 |
| FC-1 | 7 | 8 | 9 | 4 | 5 | 6 |

PET 35 Polyethylene Terephthalate

| | | | | | | |
|---|---|---|---|---|---|---|
| Control | 1 | 1 | 1 | 0 | 0 | 1 |
| FC-1 | 3 | 4 | 4 | 2 | 3 | 3 |

BASF Ultramid ™B-3 Nylon

| | | | | | | |
|---|---|---|---|---|---|---|
| Control | 0 | 0 | 0 | 0 | 0 | 0 |
| FC-1 | 2 | 2 | 2 | 1 | 1 | 1 |

### Concentration Dependence of Fluorochemical Graft Polymer in Non-Woven Fabric

The polymer used above, Escorene™PP3505, was subjected to Water Repellency tests at 5 and 120 min. and Oil Repellency tests at 5 min. at 0.5, 0.75, 1.00 and 1.5 weight percent, based on total weight. The following values were noted:

Escorene ™PP 3505

| | |
|---|---|
| Water Repellency | Oil Repellency |

| Concentration | 5 Minutes | 120 Minutes | 5 Minutes |
|---|---|---|---|
| 0.5 | 3 | 4 | 0 |
| 0.75 | 5 | 4 | 1 |
| 1.00 | 8 | 7 | 3 |
| 1.5 | 8 | 8 | 4 |

### Film Incorporating Fluorochemical Graft Polymer

To the polymer used above and identified as Escorene™PP 3505 from Exxon Chemical Company, was added 1.25% by weight of FC-1. The mixture was made into a film, according to the following procedure, as was the control material, which comprised the Escorene polymer with no additive.

A sandwich construction was assembled consisting of a rectangular steel plate of 25.4 cm length and 15.3 cm width, a copper foil of dimensions similar to those of the steel plate, and a rectangular steel shim of 25.4 cm length, 15.3 cm width and 254 microns thickness in which a centered rectangular cutout of 10.1 cm by 8.7 cm was made. Next, 2.5 g of spunbond polypropylene was folded into the center of the cutout area with approximate open margin border of approximately 1 cm on each side. The fabric was covered with more copper foil and another rectangular steel plate of the same dimensions used in the rest of the construction. The sandwich construction was placed between the plates of a press, each plate being heated to 200° C., and the plates were brought together with a force of 5 tons for a 4 inch (10.2 cm) diameter circle (587,000 kg/m²) for 2 minutes. Afterwards, the sandwich construction was removed form the heated plates and was placed between two unheated plates on the press at a much lower pressure to cool for 1 minute. The construction was disassembled and the film extracted for testing.

The films were subjected to Water, Alcohol and Oil Repellency tests as described above. The following properties were noted.

| | Film Thickness | Water Repellency | Alcohol Repellency | Oil Repellen |
|---|---|---|---|---|
| Control | 10.6 | 4 | 1 | 0 |
| 1.25% FC-1 | 11.0 | 9 | 6 | 4 |

### Epoxy Castings Using Fluorochemical Graft Polymer

A composition containing 1.25% of FC-1 was made into epoxy castings from a two-part, room temperature curable, thermoset epoxy resin system (3M Scotch-Weld™ 2158 B/A Epoxy Adhesive Tube Kit) with and without the fluorochemical graft polymer additive (for the control). After curing, the castings were submitted to testing as reported below.

| | Water Repellency | Oil Repellency |
|---|---|---|
| Control | 2 | 1 |
| 1.25% FC-1 | 10 | 8 |

Various modifications and alterations of this invention will be apparent to those skilled in the art without departing from the scope and spirit of this invention, and it should be understood that this invention is not limited to the illustrative embodiments as set forth herein.

What is claimed is:

1. A hydrophobic, oleophobic and alcohol resistant fiber comprising a synthetic organic polymer and one or more fluorochemicals selected from the group consisting of graft polymers comprising a reactive group graft-modified polyolefin backbone with which are reacted m moles of one or more groups of the formulae
[(Rƒ)n-Q-O]— (I)
[(Rƒ)n-Q-C(O)—O]— (II)
[(Rƒ)n-Q-N(R₁)]— (III)
[(Rƒ)n-Q-C(O)—N(R₂)] (IV)
[(Rƒ)n-Q-S]— (V)
[(Rƒ)n-Q-N(R₃)—O]— (VI)
[(Rƒ)n-Q-OC(O)]— (VII)
[(Rƒ)nQ-N(R₄)—C(O)]— (VIII) 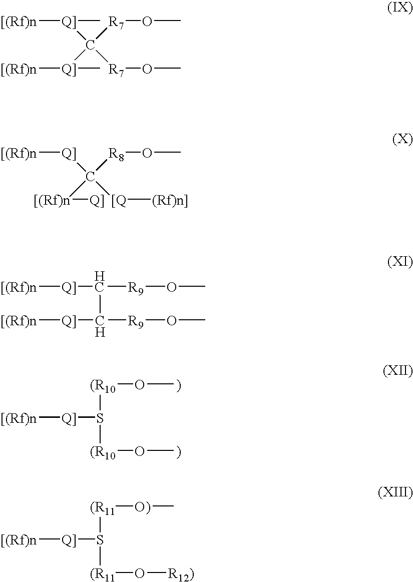
in which Rƒ is a fluorinated straight-chain or branched alkyl group bonded through carbon; n is 1 or 2; Q is a divalent or trivalent linking group, where the divalent linking group can be a covalent bond or Q may be a straight-chain or branched alkyl group, alkoxy group or alkylthio group; R₁ through R₁₂ are independently selected from the group consisting of a hydrogen atom or a substituted or unsubstituted alkyl group; and m is a number between about 4 and about r, r being the number of reactive groups in the modified olefin polymer.

2. The fiber of claim 1 wherein said fiber is spunbond or is a blown microfiber.

3. A multilayer article comprising a first layer composed of a spunbond fabric, a second layer composed of meltblown fabric, and a third layer composed of spunbond fabric wherein at least one of said layers comprises the fiber of claim 1.

4. The fiber of claim 1, wherein said reactive groups are selected from the group consisting of carboxylic acid groups and anhydride groups.

5. The fiber of claim 1, wherein m is a number between about 6 and about r.

6. The fiber of claim 1, wherein m is a number between about 10 and about r.

7. A film comprising a synthetic organic polymer and one or more fluorochemicals selected from the group consisting of graft polymers comprising a reactive group graft-modified polyolefin backbone with which are reacted m moles of one or more groups of the formulae
[(Rƒ)n-Q-O]— (I)
[(Rƒ)n-Q-C(O)—O]— (II)
[(Rƒ)n-Q-N(R₁)]— (III)
[(Rƒ)n-Q-C(O)—N(R₂)] (IV)
[(Rƒ)n-Q-S]— (V)
[(Rƒ)n-Q-N(R₃)—O]— (VI)
[(Rƒ)n-Q-OC(O)]— (VII)
[(Rƒ)nQ-N(R₄)—C(O)]— (VIII) 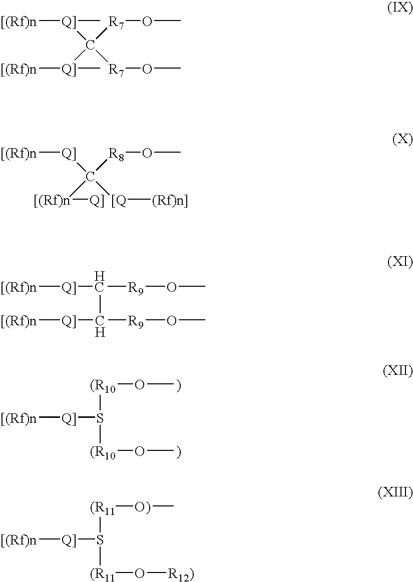
in which Rƒ is a fluorinated straight-chain or branched alkyl group bonded through carbon; n is 1 or 2; Q is a divalent or trivalent linking group, where the divalent linking group can be a covalent bond or Q may be a straight-chain or branched alkyl, alkoxy or alkylthio group; R₁ through R₁₂ are independently selected from the group consisting of a hydrogen atom or a substituted or unsubstituted alkyl group; and m is a number between about 4 and r, r being the number of reactive groups in the modified olefin polymer.

8. The film of claim 7, wherein the film is microporous.

9. The film of claim 7, wherein said reactive groups are selected from the group consisting of carboxylic acid groups and anhydride groups.

10. The film of claim 7, wherein m is a number between about 6 and about r.

11. The film of claim 7, wherein m is a number between about 10 and about r.

12. A method of rendering synthetic organic polymers hydrophobic, oleophobic and alcohol resistant, comprising blending with the polymer one or more fluorochemicals selected from the group consisting of compounds of graft polymers comprising a reactive group graft-modified polyolefin backbone with which are reacted m moles of one or more groups of the formulae
[(Rƒ)n-Q-O]— (I)
[(Rƒ)n-Q-C(O)—O]— (II)
[(Rƒ)n-Q-N(R₁)]— (III)
[(Rƒ)n-Q-C(O)—N(R₂)] (IV)
[(Rƒ)n-Q-S]— (V)
[(Rƒ)n-Q-N(R₃)—O]— (VI)
[(Rƒ)n-Q-OC(O)]— (VII)
[(Rƒ)nQ-N(R₄)—C(O)]— (VIII) 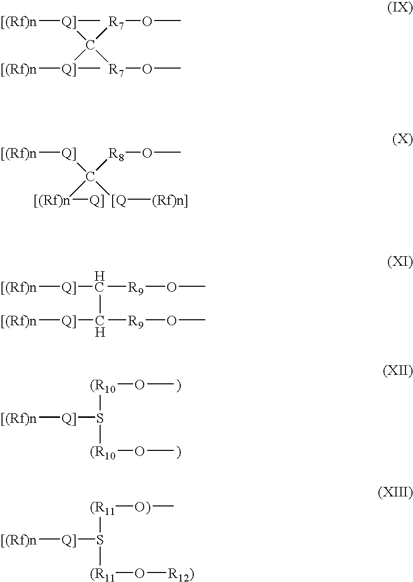
in which Rƒ is a straight-chain or branched fluorinated alkyl group bonded through carbon; n is 1 or 2; Q is a divalent or trivalent linking group, where the divalent linking group can be a covalent bond or Q may be a straight-chain or branched alkyl, alkoxy or alkylthio group; R₁ through R₁₂ are independently selected from the group consisting of a hydrogen atom or a substituted or unsubstituted alkyl group; and m is a number between about 4 and about r, r being the number of reactive groups in the modified olefin polymer.

13. The method of claim 12, wherein said reactive groups are selected from the group consisting of carboxylic acid groups and anhydride groups.

14. The method of claim 12, wherein m is a number between about 6 and about r.

15. The method of claim 12, wherein m is a number between about 10 and about r.

16. A molded article comprising a synthetic organic polymer and one or more fluorochemicals selected from the group consisting of graft polymers comprising a reactive group graft-modified polyolefin backbone with which are reacted m moles of one or more groups of the formulae
[(Rƒ)n-Q-O]— (I)
[(Rƒ)n-Q-C(O)—O]— (II)
[(Rƒ)n-Q-N(R₁)]— (III)
[(Rƒ)n-Q-C(O)—N(R₂)] (IV)
[(Rƒ)n-Q-S]— (V)
[(Rƒ)n-Q-N(R₃)—O]— (VI)
[(Rƒ)n-Q-OC(O)]— (VII)
[(Rƒ)nQ-N(R₄)—C(O)]— (VIII) 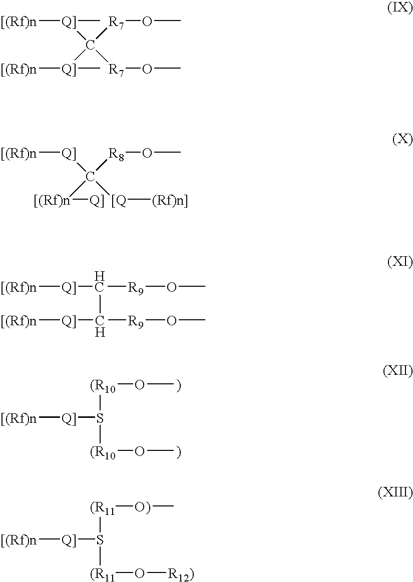
in which Rƒ is a fluorinated alkyl group bonded through carbon; n is 1 or 2; Q is a divalent or trivalent linking group, where the divalent linking group can be a covalent bond or Q may be a straight-chain or branched alkyl, alkoxy or alkylthio group; R₁ through R₁₂ are independently selected from the group consisting of a hydrogen atom or a substituted or unsubstituted alkyl group; and m is a number between about four and r, r being the number of reactive groups in the modified olefin polymer.

17. The molded article of claim 16, wherein said reactive groups are selected from the group consisting of carboxylic acid groups and anhydride groups.

18. The molded article of claim 16, wherein m is a number between about 6 and about r.

19. The molded article of claim 16, wherein m is a number between about 10 and about r.

20. A hydrophobic, oleophobic and alcohol resistant fiber comprising a synthetic organic polymer and one or more fluorochemicals selected from the group consisting of graft polymers comprising a carboxylic acid-, anhydride-, or amine-graft modified polyolefin backbone with which are reacted h moles of one or more groups of the formula (XIV): 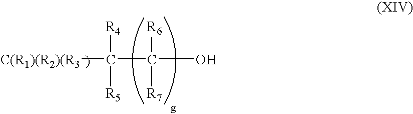
in which g is a number from about 0 to about 40 and in which R₁, R₂ R₃, R₄, R₅, R₆ and R₇ are independently selected from the group consisting of hydrogen and fluorine, wherein at least 30% of said R₁-R₇ groups are fluorine and wherein h is a number between about 4 and p, p being the number of carboxylic acid or amine groups in the backbone or twice the number of anhydride groups in the backbone.

21. A film comprising a synthetic organic polymer and one or more fluorochemicals selected from the group consisting of graft polymers comprising a carboxylic acid-, anhydride- or amine-modified polyolefin backbone with which are reacted h moles of one or more groups of the formula (XIV): 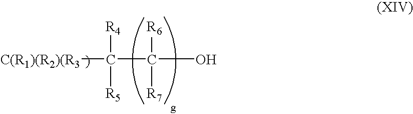
in which g is a number from about 0 to about 40 and in which R₁, R₂ R₃, R₄, R₅, R₆ and R₇ are independently selected from the group consisting of hydrogen and fluorine, wherein at least about 30% of said R₁-R₇ groups are fluorine, wherein h is a number between about 4 and p, p being the number of carboxylic acid or amine groups in the backbone or twice the number of anhydride groups in the backbone.

22. The film of claim 21 wherein the film is microporous.

23. A method of rendering a synthetic organic polymer hydrophobic, oleophobic and alcohol resistant, comprising blending with the polymer one or more fluorochemicals selected from the group consisting of graft polymers comprising a carboxylic acid-, anhydride-, or amine-graft modified polyolefin backbone with which are reacted h moles of one or more groups of the formula (XIV): 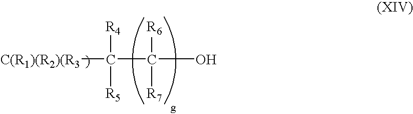
in which g is a number from about 0 to about 40 and in which R₁, R₂ R₃, R₄, R₅, R₆ and R₇ are independently selected from the group consisting of hydrogen and fluorine, wherein at least about 50% of said R₁-R₇ groups are fluorine, and wherein h is a number between about 4 and about p, p being the number of carboxylic acid or amine groups in the backbone or twice the number of anhydride groups in the backbone.

24. A molded article comprising a synthetic organic polymer and one or more fluorochemicals selected from the group consisting of graft polymers comprising a carboxylic acid-, anhydride-, or amine-graft modified polyolefin backbone with which are reacted h moles of one or more groups of the formula (XIV): 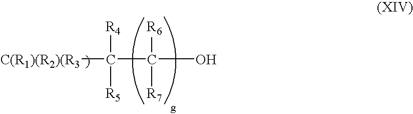
in which g is a number from about 0 to about 40 and in which R₁, R₂ R₃, R₄, R₅, R₆ and R7 are independently selected from the group consisting of hydrogen and fluorine, wherein at least about 30% of said R₁-R₇ groups are fluorine and wherein h is a number between about 4 and about p, p being the number of carboxylic acid or amine groups in the backbone or twice the number of anhydride groups in the backbone.

25. An additive which confers hydrophobic and oleophobic properties and alcohol resistance to a synthetic organic polymer compositions to which it is added which comprises a graft polymer of a polyolefin having reactive groups grafted thereto with which reactive groups are reacted at least about 30% of perfluorinated substituents by number based on the number of reactive groups grafted to said graft polymer.

26. An additive which confers hydrophobic and oleophobic properties and alcohol resistance to a synthetic organic polymer composition to which it is added which comprises one or more fluorochemical compounds comprising a reactively modified backbone with which are reacted compounds capable of conferring moieties selected from the group consisting of
[(Rƒ)n-Q-O]— (I)
[(Rƒ)n-Q-C(O)—O]— (II)
[(Rƒ)n-Q-N(R₁)]— (III)
[(Rƒ)n-Q-C(O)—N(R₂)] (IV)
[(Rƒ)n-Q-S]— (V)
[(Rƒ)n-Q-N(R₃)—O]— (VI)
[(Rƒ)n-Q-OC(O)]— (VII)
[(Rƒ)nQ-N(R₄)—C(O)]— (VIII) 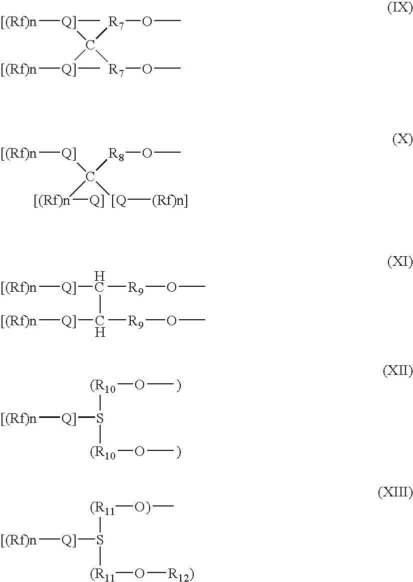
in which Rƒ is a straight-chain or branched fluorinated alkyl group bonded through carbon; n is 1 or 2; Q is a divalent or trivalent linking group, where the divalent linking group can be a covalent bond or Q may be a straight-chain or branched alkyl, alkoxy or alkylthio group; R₁ through R₁₂ are independently selected from the group consisting of a hydrogen atom or a substituted or unsubstituted alkyl group; and n is a number between about 4 and r, r being the number of reactive groups in the modified olefin polymer.

27. An additive which confers hydrophobic and oleophobic properties and alcohol resistance to a synthetic organic polymer composition to which it is added which comprises one or more fluorochemicals selected from the group consisting of graft polymers comprising a carboxylic acid-, anhydride-, or amine- graft modified polyolefin backbone with which are reacted h moles of one or more groups of the formula (XIV): 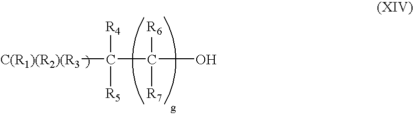
in which g is a number from about 0 to about 40 and in which R₁, R₂ R₃, R₄, R₅, R₆ and R₇ are independently selected from the group consisting of hydrogen and fluorine, wherein at least about 30% of said R₁-R₇ groups are fluorine, and wherein h is a number between about 4 and p, p being the number of carboxylic acid or amine groups in the backbone or twice the number of anhydride groups in the backbone.
